(19) United States
(12) Patent Application Publication
(10) Pub. No.: US 2012/0160633 A1
(43) Pub. Date: Jun. 28, 2012

(54) SYSTEM AND METHOD FOR PROCESSING PRODUCTS

(75) Inventors: FANG JIANG, Shenzhen City (CN); HUI LV, Shenzhen City (CN); YONG-HUA TANG, Shenzhen City (CN); YUE-QIANG TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/196,905

(22) Filed: Aug. 3, 2011

(30) Foreign Application Priority Data
Dec. 23, 2010 (CN) 201010602168.1

(51) Int. Cl. B65G 43/08; B65G 15/28

(52) U.S. Cl. 198/341.09; 198/463.3

(57) ABSTRACT

A system includes a mounting machine, a first transferring device, a second transferring device, a third transferring device, a sensor, a control device electronically connected to the second transferring device, and a catching device. The first, second, and third transferring devices are arranged in sequence along the flow line to transmit a plurality of products. The first sensor detects the plurality of products at a predefined location. The first control device controls the second transferring device to go from a flow direction of the flow line. The catching device is movable relative to the mounting machine and catches the plurality of products at the predefined location. The first transferring device transmits the plurality of products to the second transferring device along the flow direction, and the third transferring device receives the plurality of products caught by the catching device. The invention further offers a method for processing products.

### BACKGROUND

1. Technical Field

The present disclosure relates to a system and a method, more particularly to a system and method for processing products.

2. Description of Related Art

Electronic components coming from a factory need to be processed before entering the market. Usually, a number of electronic components are put into a box through manual labor, which is laborious and time-consuming.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a system for processing products in accordance with an embodiment.

FIG. 2 is a first front view of FIG. 1, and four products are located on a first transferring device.

FIG. 3 is a second front view of FIG. 1, and the four products are located on a second transferring device and in a flow line.

FIG. 4 is a third front view of FIG. 1, and the four products are located on the second transferring device and in a predefined location.

FIG. 5 is a fourth front view of FIG. 1, and a catching device catches a first one of the four products.

FIG. 6 is a fifth front view of FIG. 1, and a third transferring device is located in a predefined location receiving the first one of the four products.

FIG. 7 is a sixth front view of FIG. 1, and the third transferring device is taken with the first one of the four products on the flow line.

FIG. 8 is a seventh front view of FIG. 1, and the four products are together placed on the third transferring device.

FIG. 9 is an eighth front view of FIG. 1, and the four products are together placed on a fourth transferring device.

FIG. 10 is a flow chart of a method for processing products in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

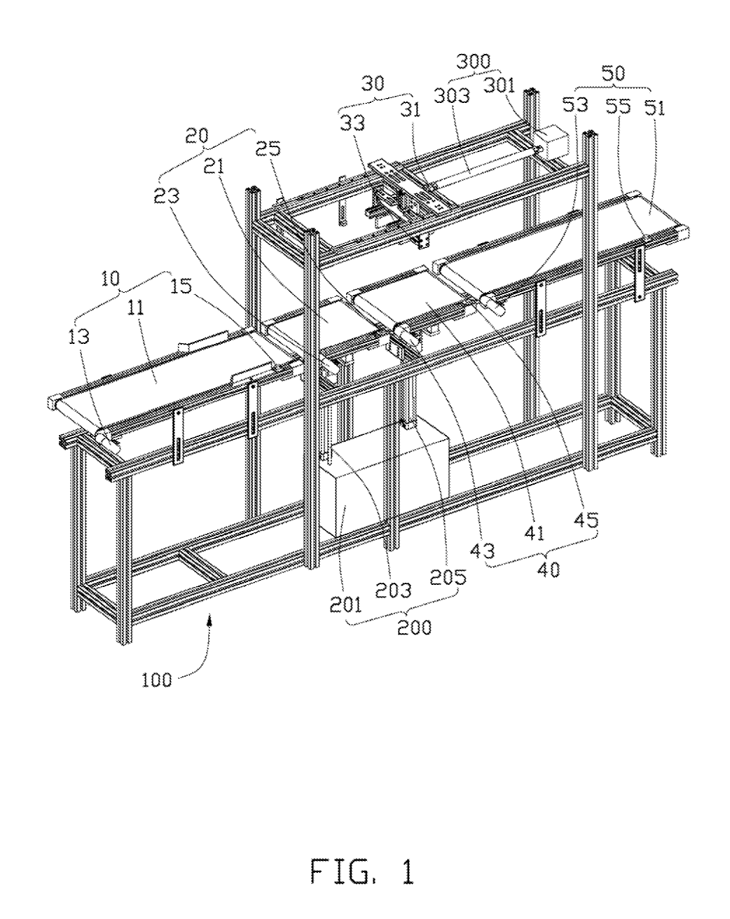

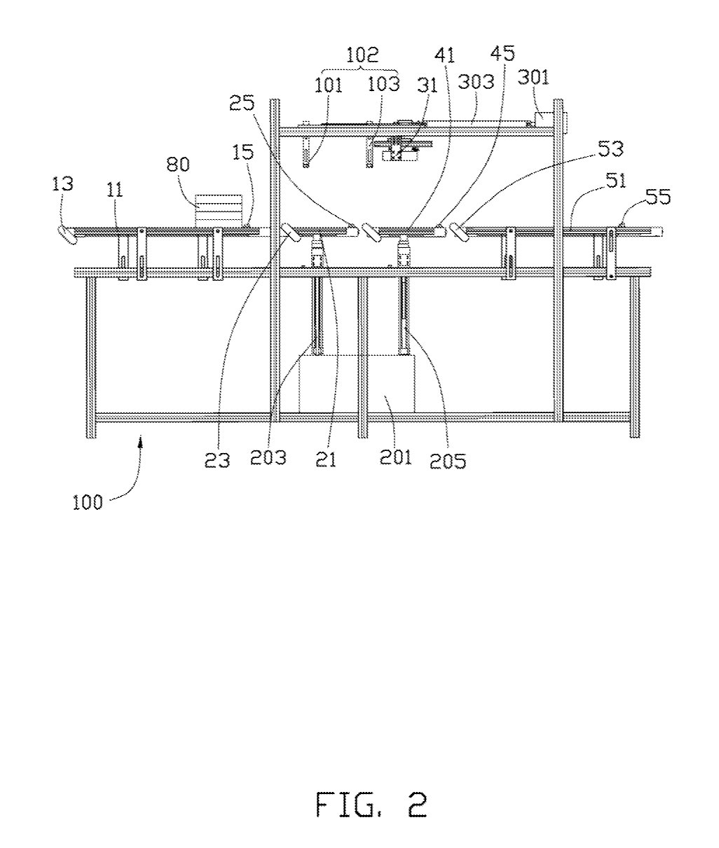

Referring to FIGS. 1 and 2, a system includes a mounting mechanism 100, a first transferring device 10, a second transferring device 20, a first control device 200, a second control device 300, a catching device 30, a third transferring device 40, and a fourth transferring device 50. In one embodiment, the devices 10-50 are mounted on the mounting mechanism 100 and are arranged in sequence along the flow line to transfer a plurality of products 80.

The mounting mechanism 100 has a sensor device 102. The sensor device 102 includes a first sensor 101 and a second sensor 103. The first and second sensors 101, 103 are used to sensor whether a product is located in at predefined locations.

The transferring device 10 includes a first belt 11, a first controller 13 (a first electromotor), and a first detector 15. The first controller 13 is located on a first end of the first belt 11. The first detector 15 is located on a second end of the first belt 11 adjacent to the second transferring device 20, in one embodiment, the first detector 15 may be an infrared detector, or a gravity detector.

The first control device 200 is electronically connected to the second and third transferring devices 20, 40, and includes a first Electro Discharge Machining (EDM) cabinet 201, a first air cylinder 203 and a second cylinder 205. The first air cylinder 203 is electronically connected to the first EDM cabinet 201 and the second transferring device 20. The second cylinder 205 is electronically connected to the first EDM cabinet 201 and the third transferring device 40.

The second control device 300 includes a second EDM cabinet 301, a third air cylinder 303 electronically connected to the second EDM cabinet 301 and the catching device 30.

The second transferring device 20 includes a second belt 21, a second controller 23 (a second electromotor), and a second detector 25. The second controller 23 is located on a first end of the second belt 21. The second detector 25 is located on a second end of the second belt 21 adjacent to the third transferring device 40, in one embodiment, the second detector 25 may be an infrared detector, or a gravity detector.

The catching device 30 includes a claw 31 and a catching detector 33. In one embodiment, the catching device 30 is adjacent to the second sensor 103.

The third transferring device 40 includes a third belt 41, a third controller 43 (a third electromotor), and a third detector 45. The third controller 43 is located on a first end of the third belt 41. The third detector 45 is located on a second end of the third belt 41 adjacent to the fourth transferring device 50, in one embodiment, the third detector 45 may be an infrared detector, or a gravity detector.

The fourth transferring device 50 includes a fourth belt 51, a fourth controller 53 (a fourth electromotor), and a fourth detector 55. The fourth controller 53 is located on a first end of the fourth belt 51. The fourth detector 55 is located on a second end of the fourth belt 51, in one embodiment, the fourth detector 55 may be an infrared detector, or a gravitational detector.

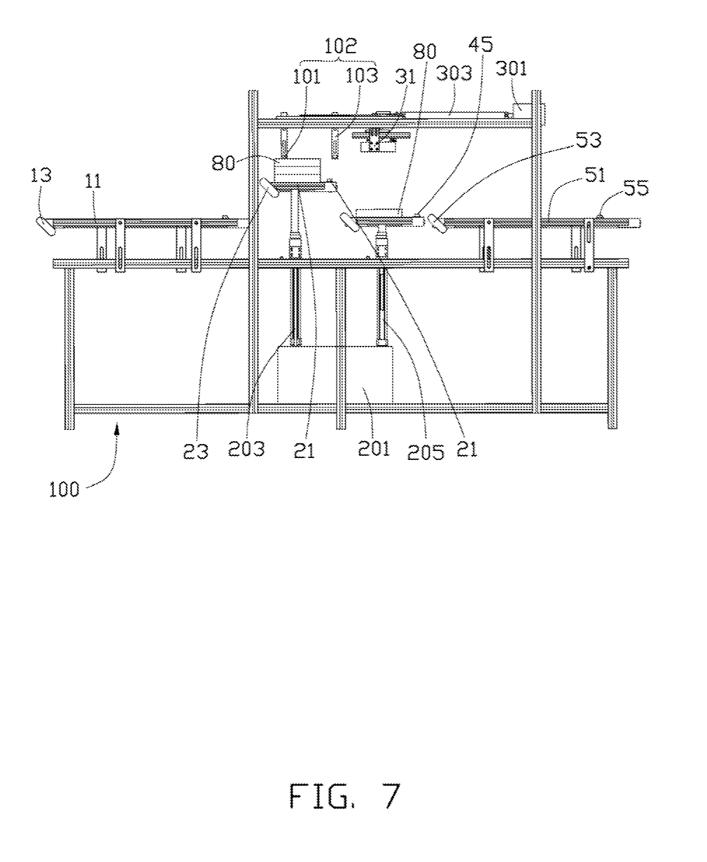

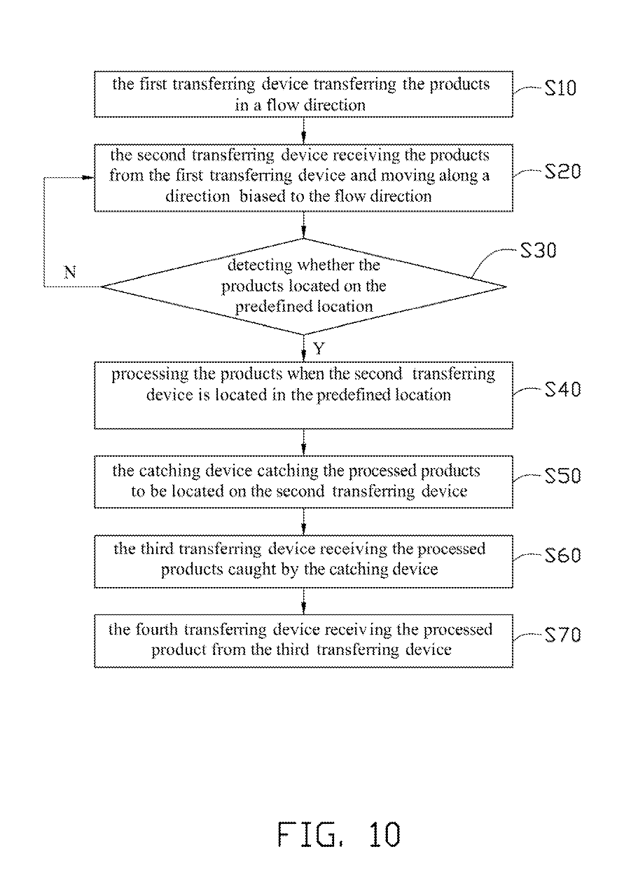

Referring to FIGS. 2-10, a process for processing products in accordance with an embodiment includes the following steps:

Step 10: the first transferring device 10 transmits a group of the products 80 along a flow direction of the flow line.

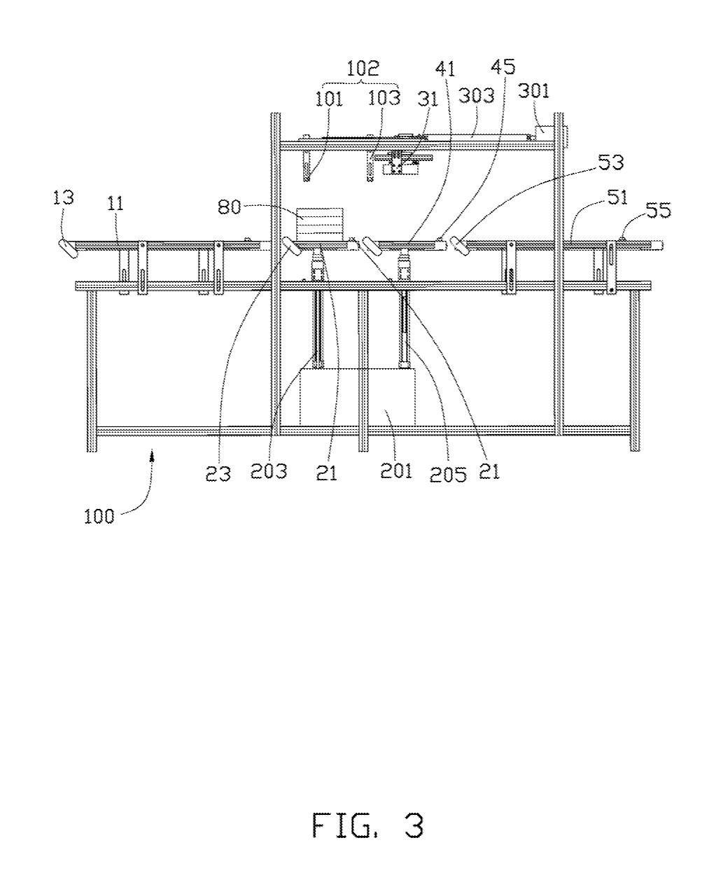

The group of product boxes 80, such as four product boxes 80, is placed on the first belt 11. The first detector 15 detects the group of product boxes 80 that is placed on the first belt 11 and sends a first signal to the first controller 13. When the first controller 13 receives the first signal of the first detector 15, the first controller 13 moves the first belt 11 along the flow direction, and the group of product boxes 80 can be moved to the second belt 21 (see FIG. 3). Then, the first detector 15 send a second signal to the first controller 13, and the controller 13 controls the first belt 11 to stop moving when receiving the second signal of the first detector 15.

Step 20: the second transferring device 20 receives the group of products 80 from the first transferring device 10 and moves along a direction substantially biased to the flow direction. In one embodiment, the direction can be substantially perpendicular to the flow direction.

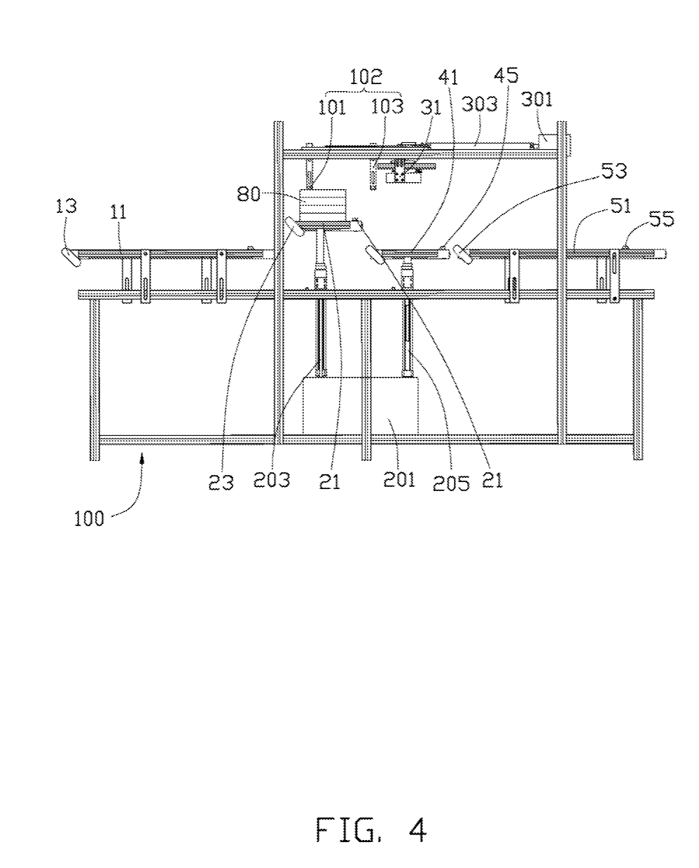

The second detector 25 detects the group of product boxes 80 is placed on the second belt 21 and send a first signal to the first control device 200. When the first control device 200 receives the first signal of the second detector 25, the first control device 200 starts the first air cylinder 201 to work. The first air cylinder 201 and the second transferring device 20 moves in unison upward (see FIG. 4), until the first sensor 101 can detect the first (top) one of the group of product boxes 80.

Step 30: the first sensor 101 detects whether the group of products 80 is located on the predefined location.

If yes, the first sensor 101 detects that the group of products 80 is located on the predefined location, the first sensor 101 sends a signal to the first control device 200. Thus, the first control device 200 stops the second transferring device 20 from moving upward. If no, the second transferring device 20 goes on moving upward.

Step 40: processing the group of products 80 when the second transferring device 20 is located in the predefined location. In one embodiment, the process can include manufacturing, assemblies, or packing.

A manipulator (not shown) automatically processes the first one of the group of product boxes 80. When the first one of the group of product boxes 80 is processed, a detector (not shown) on the manipulator sends a signal to the catching detector 33.

Step 50: the catching device 30 catches the processed product 80 to be located on the second transferring device 20.

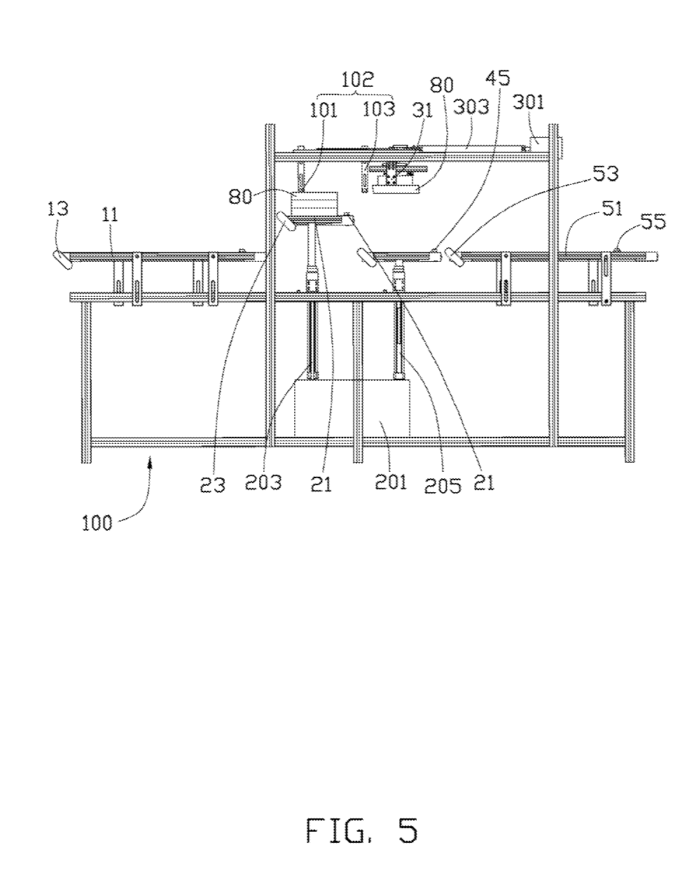

When the catching detector 33 receives the first signal of the manipulator, the second control device 300 starts the third air cylinder 303. Thus, the third air cylinder 303 pushes the catching device 30 to move towards the first sensor 103 (see FIG. 5), until the first sensor 103 can detect the group of product boxes 80. The catching device 30 catches the first one of the group of product boxes 80. The second detector 25 sends a second signal to the first control device 200, and the first air cylinder 203 moves the group of product boxes 80 upward, for waiting for the manipulator. Now, only three product boxes 80 are placed on the second belt 21, when the catching device 30 catches the first one of the group of product boxes 80, the second control device 300 starts. The third air cylinder 303 pulls the catching device 30 to move back. Thus, the second sensor 103 detects the first one of the group of product boxes 80, and sends a first signal to the first control device 200.

Step 60: the third transferring device 40 receives the processed product 80 caught by the catching device 30.

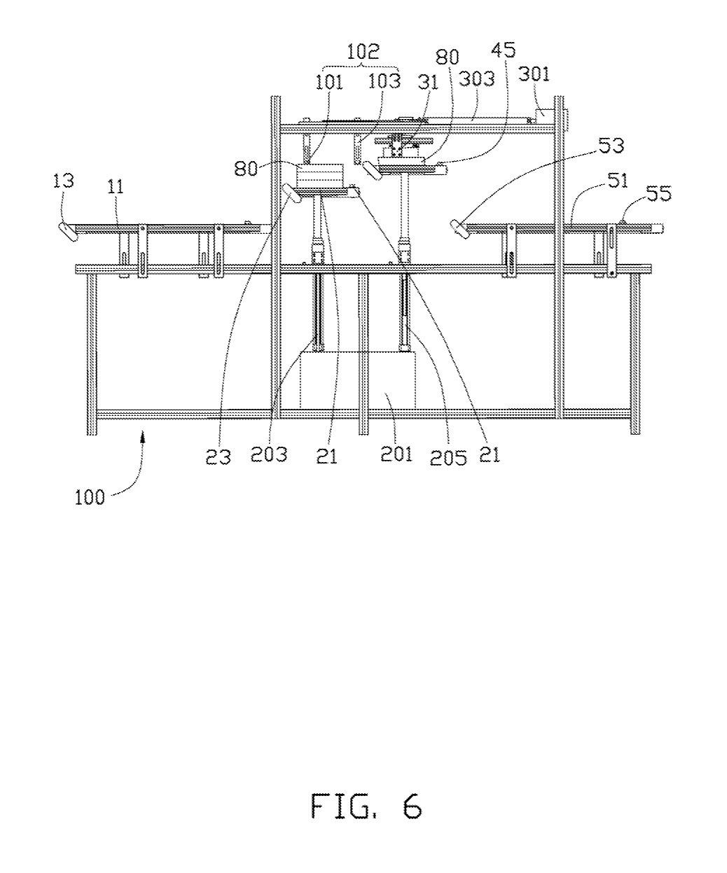

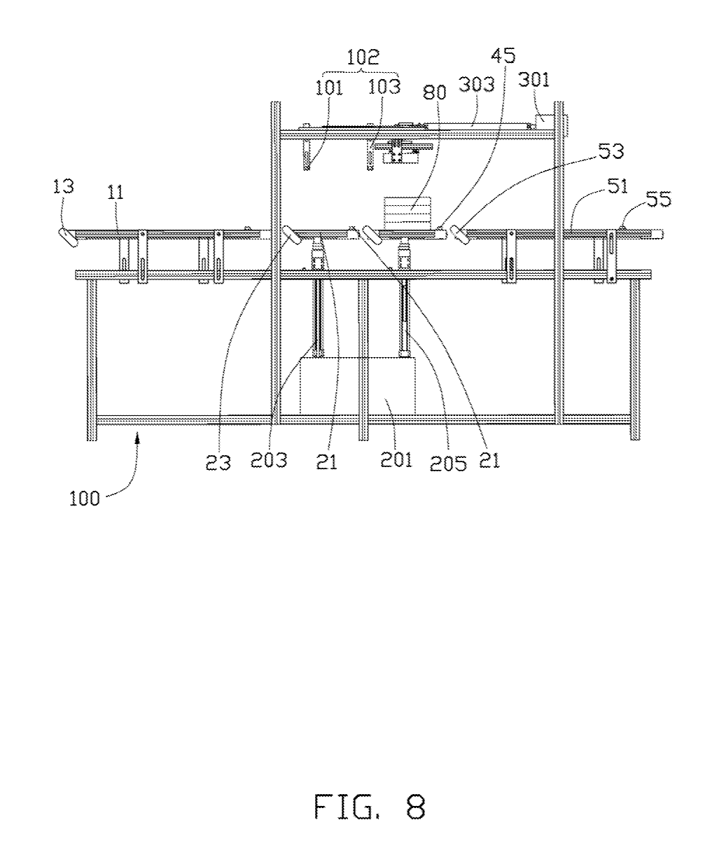

When the first control device 200 receives the first signal of the second sensor 103, the first control device 200 starts the second air cylinder 203 to move upward, until the first one of the group of product boxes 80 can be placed on the third belt 41 (see FIG. 6), and the third belt 41 is located on a predefined location. When the second sensor 103 detects the first one of the group of product boxes 80 is placed on the third belt 41, the second sensor 103 sends a second signal to the third detector 45. The third detector 45 sends a first signal to the first control device 200 when receiving the second signal of the second sensor 103. The first control device 200 starts the second air cylinder 203 to move back, waiting for next one of the group of product boxes 80. Synchronously, the third detector 45 notes the number of product 80, which has been located on the third belt. Repeat the steps 14-20, until the noted number (four) substantially equal to a predefined number has been set, and the group of product boxes 80 (four product boxes) is processed and placed on the third belt 41 (see FIG. 8). When the third detector 45 detects the noted number is equal to the predefined number, the third detector 45 sends a second signal to the third controller 43.

Step 70: the fourth transferring device 50 receives the processed product 80 from the third transferring device 40.

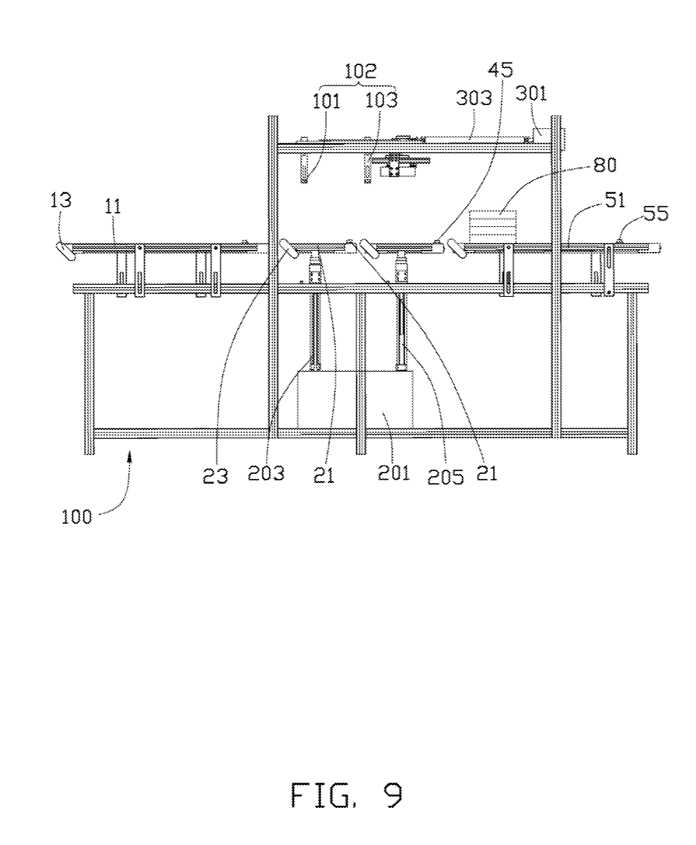

The third controller 43 starts to move the third belt 41 when receiving the second signal of the third detector 45. Thus, the group of product boxes 80 can be transmitted to the fourth belt 50 (see FIG. 9). When the fourth detector 55 detects the group of product boxes 80 has been placed on the fourth belt 50, the fourth detector 55 sends a first signal to the fourth controller 51. The fourth controller 51 starts to move the fourth belt 51 when receiving the first signal to the fourth detector 55, until the group of product boxes 80 are farthest from the third transferring device 40. Then, an alarm (not shown), attached to the mounting mechanism 100, starts, and the group of product boxes 80 can be taken from the fourth belt 51.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A system for processing products in a product flow line, the system comprising:
a mounting machine;
a first transferring device located on the mounting machine;
a second transferring device located on the mounting machine;
a third transferring device located on the mounting machine, wherein the first transferring device, the second transferring device and the third transferring device are arranged in sequence along the flow line to transmit a plurality of products;
a sensor located on the mounting machine, and adapted to detect the plurality of products at a predefined location;
a first control device electronically connected to the second transferring device, the first control device adapted to control the second transferring device to bias from a flow direction of the flow line to the predefined location; and
a catching device located on the mounting machine and movable relative to the mounting machine, and adapted to catch the plurality of products at the predefined location;
wherein the first transferring device is adapted to transmit the plurality of products to the second transferring device along the flow direction, and the third transferring device is adapted to receive the plurality of products caught by the catching device.

2. The system of claim 1, further comprising a second control device electronically connected to the catching device, and the second control device being adapted to control the catching device moveable relative to the mounting machine.

3. The system of claim 2, wherein a flow direction of the first transferring device transmitting the product to the second transferring device is substantially perpendicular to a direction of the second transferring device moving to the predefined location.

4. The system of claim 3, wherein a third direction of the catching device moving relative to mounting machine is substantially parallel to the first direction.

5. The system of claim 3, wherein the third transferring device is electronically connected to the first control device, and the first control device is adapted to move the third transferring device to bias from a flow direction of the flow line.

6. The system of claim 1, wherein the first control device comprises an Electron Discharge Machining cabinet, a first air cylinder and a second air cylinder, the first air cylinder is connected to the Electron Discharge Machining cabinet and the second transferring device, and the second air cylinder is connected to the Electron Discharge Machining cabinet and the third transferring device.

7. The system of claim 1, wherein the first transferring device comprises a first belt, a first controller located on a first end of the first belt, and a first detector located on a second end of the first belt, the first detector is adapted to detect whether the products placed on the first belt, and the first controller is adapted to move the first belt according to the indicating of the first detector.

8. The system of claim 1, wherein the third transferring device comprises a second belt and a second detector located on the second belt, and the second detector is adapted to detect whether the products placed on the second belt and note the number of the products.

9. The system of claim 1, further comprising a fourth transferring device adjacent to the third transferring device, and the fourth transferring device being adapted to receive the products from the third transferring device.

10. A method for processing products in a product flow line comprising:
transferring a product along a flow direction of the flow line;
moving the product along a direction substantially biasing to the flow direction to a predefined location;
processing the product upon a condition that the product is placed at the predefined location;
removing the processed product from the predefined location; and
moving the processed product back to the flow line.

11. The method of claim 10, wherein the removing the processed product from the predefined location further comprises removing the processed product along the direction biasing to the flow direction.

12. The method of claim 11, wherein the removing the processed product from the predefined location further comprises moving the product along a direction substantially parallel to the flow direction.

13. The method of claim 10, further comprising noting the number of the processed product after the moving the processed product back to the flow line.

14. The method of claim 13, further comprising taking the product off the product flow line after a noted number is substantially equal to a predefined number of the processed product.

15. The method of claim 10, wherein the flow direction is substantially perpendicular to a direction of moving the product to the predefined location.

16. The method of claim 10, wherein the flow direction is substantially parallel to a direction of removing the processed product from the predefined location.
